(19) United States
(12) Patent Application Publication
(10) Pub. No.: US 2020/0053419 A1
(43) Pub. Date: Feb. 13, 2020

(54) Enabling a Media Orchestration

(71) Applicants: Koninklijke KPN N.V., Rotterdam (NL); Nederlandse Organisatie Voor Toegegast Natuurwetenschappelijk Onderzoek TNO, s-Gravenhage (NL)

(72) Inventors: Mattijs Oskar Van Deventer, Leidschendam (NL); Hans Maarten Stokking, Wateringen (NL)

(21) Appl. No.: 16/338,939

(22) PCT Filed: Oct. 12, 2017
(86) PCT No.: PCT/EP2017/076011

§ 371 Date: Apr. 2, 2019

(30) Foreign Application Priority Data
Oct. 12, 2016 (EP) 16193444.3

(51) Int. Cl. H04N 21/438; H04N 21/242; H04N 21/258; H04N 21/43; H04N 21/45; H04N 21/8547; H04N 21/643

(52) U.S. Cl. CPC H04N 21/4383; H04N 21/242; H04N 21/25841; H04N 21/643; H04N 21/4516; H04N 21/4524; H04N 21/8547; H04N 21/4302

(57) ABSTRACT

The invention relates to methods of enabling a media orchestration. A media orchestration orchestrates multiple devices to process at least one media stream. The first method, e.g. performed by a client device, involves receiving (1) communication channel setup information relating to a certain media orchestration, transmitting (3) a request to a controller system based on the communication channel setup information, the request representing a first step to establish a communication channel between the client device and the controller system in relation to the certain media orchestration, and receiving (11) control information over the communication channel from the controller system after said communication channel has been established. The second method, e.g. performed by the controller system, involves receiving (5) the request, determining (7) an orchestration session based on the request, and transmitting (9) control information relating to the orchestration session over the communication channel to the client device after said communication channel has been established.

### FIELD OF THE INVENTION

The invention relates to methods of enabling a media orchestration, said media orchestration orchestrating multiple devices to process at least one media stream.

The invention also relates to a computer program product enabling a computer system to perform any of such methods.

The invention further relates to a client device for enabling a media orchestration and a controller system for enabling a media orchestration, said media orchestration orchestrating multiple devices to process at least one media stream.

### BACKGROUND OF THE INVENTION

The Moving Picture Experts Group (MPEG) is a working group of authorities that was formed by ISO and IEC to set standards for audio and video compression and transmission. After recently creating standards for High Efficiency Coding and Media Delivery in Heterogeneous Environments (MPEG-H) and Dynamic Adaptive Streaming over HTTP (MPEG-DASH), MPEG has started working on creating a standard for Media Orchestration (MPEG-MORE). The publication “Context and Objectives for Media Orchestration v.3” (N 16131), published in the MPEG meeting 114 of ISO/IEC JTC1/SC29/WG11 in February 2016, San Diego, Calif., US, provides an initial description of the context and objectives for MPEG-MORE. Media Orchestration includes orchestration of media capture, orchestration of media consumption and orchestration of media transformation. Media orchestration does not include media delivery.

Orchestration of media capture is about controlling which device captures what and when and how and how they make this available. What they capture is about their location and orientation and their capabilities for capture, e.g. zoom capabilities. When they capture is about starting and stopping capture. How to capture this is about frame rate, resolution, microphone gain, white balance settings, etc. How they make this available is about things like codecs used, metadata delivered, possible transformations to be applied.

Orchestration of media consumption or presentation is about controlling which device plays out what and when and how. What to play out is about what content to retrieve and which parts of that content should be played out. When to play out is about playout synchronization with other devices. How to play out is about where exactly to play out something, e.g. positioning of a content part in a screen, positioning of an audio object in a room, possible transformations to be applied, e.g. volume or brightness adjustments.

Orchestration of media transformation is about applying transformations to captured media. This may be changing the way a captured content is, e.g. changing frame rate, encoding, applying certain filters or masks, etc. This may also be combining content, e.g. performing stitching or combining input for enhancement of input. Editing of content may also be seen as part of this, changing the arrangement of content in space and time, e.g. compare this with the creation of a complete movie out of various shots and recordings.

Unlike SMIL (Synchronized Multimedia Integration Language, a standard published by the Worldwide Web Consortium), which is server-centric, i.e. a server manages playback devices, MPEG-MORE is client device-centric (sources and sinks are collectively referred to as “client devices” in this specification). In a conventional client device-centric architecture, a client periodically retrieves a new configuration file. This has the disadvantage that a server has no way to cause clients to retrieve a new configuration immediately, but the advantage of easy communication through firewalls.

“Context and Objectives for Media Orchestration v.3” introduces the concepts of an Orchestrator function and a Controller function, but does not describe what control information a Controller function transmits or how an Orchestrator function communicates with client devices. Neither SMIL nor “Context and Objectives for Media Orchestration v.3” specifies how to achieve real-time coordination of client devices in relation to media orchestration in a client device-centric architecture.

### SUMMARY OF THE INVENTION

It is a first object of the invention to provide a method of enabling a media orchestration for performance by a client device, which helps achieve real-time coordination of client devices in relation to media orchestration in a client device-centric architecture.

It is a second object of the invention to provide a method of enabling a media orchestration for performance by a controller system, which helps achieve real-time coordination of client devices in relation to media orchestration in a client device-centric architecture.

It is a third object of the invention to provide a client device for enabling a media orchestration, which helps achieve real-time coordination of client devices in relation to media orchestration in a client device-centric architecture.

It is a fourth object of the invention to provide a controller system for enabling a media orchestration, which helps achieve real-time coordination of client devices in relation to media orchestration in a client device-centric architecture.

According to the invention, the first object is realized in that the method of enabling a media orchestration comprises receiving communication channel setup information relating to a certain media orchestration at a client device, transmitting a request to a controller system based on said communication channel setup information, said request representing a first step to establish a (e.g. bi-directional) communication channel between said client device and said controller system in relation to said certain media orchestration, and receiving control information over said communication channel at said client device from said controller system. The method may further comprise transmitting status information over said communication channel to said controller system after said communication channel has been established.

The inventors have recognized that in a client device-centric architecture, it is not optimal to have client devices poll other client devices or a server in order to achieve the real-time coordination required for certain aspects of media orchestration. To achieve this real-time coordination, the inventors have realized an architecture in which a communication channel to a centralized function is used. To maintain a client device-centric architecture, the client device takes the initiative in setting up this communication channel. However, once the communication channel has been established, control information may be sent from the controller system to the client device, without waiting for a next polling time (this may not exclude that the client device can send status information to the controller system).

As an additional advantage, the invention reduces problems with firewalls and deals with NAT traversal, which may prohibit a server from setting up a connection with a client device, but not prohibit a client device from setting up a connection with a server. As another additional advantage, the invention may make sending multiple control messages more efficient, as less header information is required. For example, control messages do not have to refer to the orchestration session in each message, as this connection is only used for one specific session. A communication channel is thus preferably used for a single orchestration session, but may also be used for multiple orchestration sessions in which the same client device participates (and which are controlled by the same controlling system) if necessary.

A further advantage of the invention is that the controller process running on the controller system may be relatively lightweight. Maintaining the channel itself does not require any significant processing power and the controller system may not need to perform any essential tasks in order for the media streaming process to occur. This allows the controller system to handle large numbers of client device simultaneously. Another advantage of the invention is that the communication channel may not need to be a vital aspect of the media streaming process. Should the channel be momentarily broken/dropped, for example due to a network disruption, this does not prevent the client device from requesting and playing out media streams.

The client device may comprise a source of media data and/or meta data (e.g. a camera, microphone or any device comprising a sensor providing media data or meta data related to media experience) and/or a sink for media data and/or meta data (e.g. a TV, smartphone, tablet, PC, VR device e.g. HMD), for example. The controller system may comprise one or more controller devices. The controller system may implement the Controller function and/or the Orchestrator function as specified in “Context and Objectives for Media Orchestration v.3”, for example. Alternatively, the controller system may forward orchestration data from the Orchestrator function as specified in “Context and Objectives for Media Orchestration v.3” to client devices, for example.

Said communication channel setup information may comprise an address, e.g. a Uniform Resource Identifier (URI), of said controller system, one or more protocol identifiers identifying one or more protocols that may be used to access said controller system and/or an orchestration session identifier. An address may be a URI, e.g. a fully qualified domain name, or an IP address or the like. However, the invention may also be on networks that use another form of addressing. The communication channel setup information may be part of an initial configuration, for example. Alternatively, the initial configuration may be obtained via the communication channel after it has been established, for example. If the controller system does not implement the afore-mentioned Orchestrator function, the communication channel setup information may be part of information that also allows the client device to find a system that implements this Orchestrator function. Control information may comprise MPEG MORE messaging & control and/or orchestration data, for example.

Said method may further comprise the step of including an identifier in said request, said identifier enabling said controller system to determine an orchestration session. Said identifier may also enable said controller system to determine that the orchestration session is controlled by another controller system. Said identifier may comprise an orchestration session identifier and/or a location identifier. The location identifier may comprise GPS coordinates, an IP address and/or an SSID of a wireless network, for example. The location identifier may be used, for example, to ensure that playback devices in the same geographical area and/or that capture devices in the same geographical area are part of the same orchestration session.

Additionally or alternatively, devices may share their orchestration session identifier to ensure that they end up in the same orchestration session. This further allows device owners to keep sessions more private or exclusive. If the client device is not able to determine this identifier, the controller system may be able to determine the relevant orchestration session without an identifier received from the client device. All client devices that participate in the same media orchestration are part of the same orchestration session and client devices that are part of the same orchestration session should be orchestrated together. The capturing of certain media data and the playback of this media data may be separate orchestrations. In this case, there may be multiple orchestration sessions.

According to the invention, the second object is realized in that the method of enabling a media orchestration comprises receiving a request from a client device at a controller system, said request representing a first step to establish a (e.g. bi-directional) communication channel between said client device and said controller system in relation to a certain media orchestration, determining an orchestration session based on said request, and transmitting control information relating to said orchestration session over said communication channel to said client device. The method may further comprise receiving status information over said communication channel at said controller system from said client device after said communication channel has been established.

Determining an orchestration session may comprise determining an orchestration session associated with one or more further client devices participating in the same media orchestration. If another client device is already participating in the same orchestration, the controller system may group them together in the same orchestration session.

Said method may further comprise determining that at least one of said one or more further client devices has stopped participating in the same media orchestration, determining new control information in response to determining that said at least one of said one or more further client devices has stopped participating in the same media orchestration, and transmitting said new control information over said communication channel to said client device. One of the situations in which immediate action is necessary is when one of the other client devices in a media orchestration stops participating. For example, this other client device may be responsible for capturing or playing back a certain part of the media data and a remaining client device may be requested to capture or playback a different or additional part of the media data to compensate for this other client device no longer participating. Note that this may lead to the situation that only a single client is, at least at a certain point in time, the only client in a media orchestration session. Normally, media orchestration sessions are about orchestrating the behaviour of multiple clients, but this does not prevent orchestration sessions from temporarily consisting of only a single client, e.g. starting or ending the session with only a single client.

Said method may further comprise determining an identifier in relation to said request and determining an orchestration session may comprise determining said orchestration session based on said identifier. The identifier may be determined from the request, for example. The identifier may comprise an orchestration session identifier and/or a location identifier determined by the client device, for example. Alternatively or additionally, the identifier may be determined using other information. The identifier may comprise or may be determined from a location identifier determined by a mobile communication network for the client device, for example. A location identifier may be advantageous in certain media orchestration scenarios where devices are relatively close together, e.g. to orchestrate camera phones when multiple camera phones record a same event.

According to the invention, the third object is realized in that the client device for enabling a media orchestration comprises a communication interface and at least one processor configured to use said communication interface to receive communication channel setup information relating to a certain media orchestration, to use said communication interface to transmit a request to a controller system based on said communication channel setup information, said request representing a first step to establish a (e.g. bi-directional) communication channel between said client device and said controller system in relation to said certain media orchestration, and to use said communication interface to receive control information over said communication channel from said controller system after said communication channel has been established.

Said communication channel setup information may comprise an address, e.g. a Uniform Resource Identifier, of said controller system, one or more protocol identifiers identifying one or more protocols that may be used to access said controller system and/or an orchestration session identifier.

Said at least one processor may be configured to include an identifier in said request, said identifier enabling said controller system to determine an orchestration session. Said identifier may comprise an orchestration session identifier and/or a location identifier.

According to the invention, the fourth object is realized in that the controller system for enabling a media orchestration comprises a communication interface and at least one processor configured to use said communication interface to receive a request from a client device, said request representing a first step to establish a (e.g. bi-directional) communication channel between said client device and said controller system in relation to a certain media orchestration, to determine an orchestration session based on said request, and to use said communication interface to transmit control information relating to said orchestration session over said communication channel to said client device after said communication channel has been established.

Said at least one processor may be configured to determine an orchestration session associated with one or more further client devices participating in the same media orchestration based on said request.

Said at least one processor may be configured to determine that at least one of said one or more further client devices has stopped participating in the same media orchestration, to determine new control information in response to determining that said at least one of said one or more further client devices has stopped participating in the same media orchestration, and to use said communication interface to transmit said new control information over said communication channel to said client device.

Said at least one processor may be configured to determine an identifier in relation to said request and to determine an orchestration session based on said identifier. Said identifier may comprise an orchestration session identifier and/or a location identifier.

Said controller system may comprise a single device. This is the most efficient way of ensuring coordination between all client devices that participate in the same media orchestration and prevents communication between multiple devices of a controller system causing communication delays between client devices and controller system. Alternatively, a controller system may comprise multiple controller devices, for example. The controller system may be a cloud-based system running on various physical servers, for example. The controller system may have a federated architecture, for example. One controller device may act as a proxy for one or more other controller devices towards client devices, for example.

If the controller system cooperates with one or more other controller systems, the controller system determines, e.g. using the identifier included in the request, whether it is the one responsible for the media orchestration that the client device requests to participate in. If the client device does not know exactly which controller system is responsible for this media orchestration, the controller system may be able to refer the client device to another controller system.

A user of the client device may be able to select a certain media orchestration from a list to allow the client device to obtain the communication channel setup information. If the client device does not know exactly which controller system is responsible for a certain media orchestration, the client device should at least know/find an URI of another controller system that cooperates with the responsible controller system. If every controller system cooperates with each other, the client device may contact a default controller system, e.g. pre-configured in the client device, or a local controller system found using a local resolution mechanism like DHCP.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations comprising: receiving communication channel setup information relating to a certain media orchestration at a client device, transmitting a request to a controller system based on said communication channel setup information, said request representing a first step to establish a (e.g. bi-directional) communication channel between said client device and said controller system in relation to said certain media orchestration, and receiving control information over said communication channel at said client device from said controller system after said communication channel has been established.

The same or a different non-transitory computer-readable storage medium stores at least one further software code portion, the further software code portion, when executed or processed by a computer, being configured to perform executable operations comprising: receiving a request from a client device at a controller system, said request representing a first step to establish a (e.g. bi-directional) communication channel between said client device and said controller system in relation to a certain media orchestration, determining an orchestration session based on said request, and transmitting control information relating to said orchestration session over said communication channel to said client device after said communication channel has been established.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java(™), Smalltalk, C++ or the like and conventional procedural programming languages, such as the “C” programming language and scripting or scripting-like programming languages such as JavaScript, Python, PHP and Perl or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a flow diagram of a first embodiment of the methods of the invention;

FIG. 2 is a flow diagram showing additional steps performed in a second embodiment of the methods of the invention;

FIG. 3 is a block diagram of a first embodiment of the controller system and client device of the invention;

FIG. 4 is a block diagram of a second embodiment of the controller system and client device of the invention;

FIG. 5 is a block diagram of a third embodiment of the client device of the invention, which uses a lookup server;

FIG. 6 is a block diagram of a third embodiment of the controller system of the invention;

FIG. 7 is a block diagram of a fourth embodiment of the controller system of the invention; and

FIG. 8 is a block diagram of an exemplary data processing system for performing the methods of the invention.

Corresponding elements in the drawings are denoted by the same reference numeral.

### DETAILED DESCRIPTION OF THE DRAWINGS

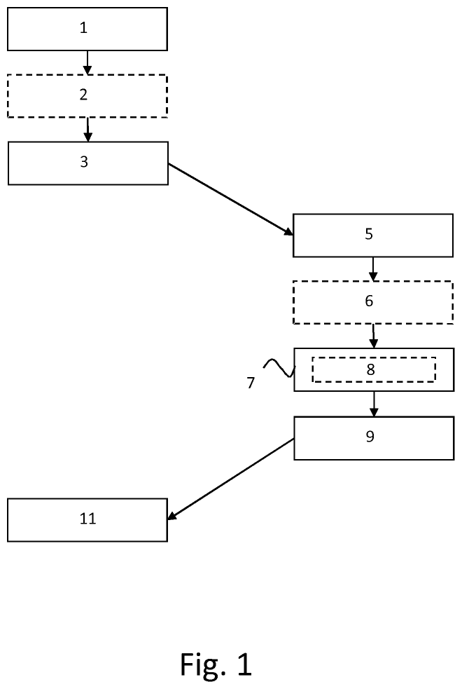

A flow diagram of a first embodiment of the methods of enabling a media orchestration of the invention is shown in FIG. 1. A media orchestration orchestrates multiple devices to process at least one media stream. A step 1 comprises a client device receiving communication channel setup information relating to a certain media orchestration. A step 3 comprises the client device transmitting a request to a controller system based on the communication channel setup information. The request represents a first step to establish a communication channel between the client device and the controller system in relation to the certain media orchestration. A step 5 comprises the controller system receiving the request from the client device.

Transmitting the request may involve transmitting a request to establish a (e.g. WebSocket) connection or the request may be transmitted over a (e.g. WebSocket) connection after it has been established. In the first case, the controller system may assume that the client device only transmits the connection request to him if he is the appropriate controller system and therefore always accepts the connection request. Alternatively, the controller system may take the IP address from which the connection request originates or the session identifier into account when deciding whether to accept the connection request. The session identifier may be part of the connection request, e.g. it may be included in the HTTP header of a WebSocket handshake. In this first case, acceptance of the connection request means that the communication channel request is accepted and the communication channel is established. In the second case, the controller system may still decide whether to accept the communication channel request transmitted over the established connection or not. If the controller system accepts the communication channel request, the communication channel may be established on the already existing connection, for example.

A step 7 comprises the controller system determining an orchestration session based on the request. If the controller system accepts the request, it may transmit a response to the client device indicating that the request has been accepted (not shown in FIG. 1), for example. Alternatively, if the controller system accepts the request, the controller system may simply start to transmit control information, for example. In both cases, the communication channel has been established. A step 9 comprises the controller system transmitting control information relating to the orchestration session over the communication channel to the client device. A step 11 comprises the client device receiving the control information over the communication channel from the controller system. The communication channel setup information may comprise an address, e.g. a Uniform Resource Identifier, of the controller system, one or more protocol identifiers identifying one or more protocols that may be used to access the controller system and/or an orchestration session identifier, for example.

In an embodiment, see FIG. 1, the methods further comprise an optional step 2 of the client device including an identifier in the request before transmitting the request in step 3 and/or optional steps of the controller system, i.e. a step 6 of determining an identifier in relation to the request (which may have been provided step 2) and a step 8 of determining the orchestration session based on the identifier, which may be part of step 7. The identifier may comprise an orchestration session identifier and/or a location identifier.

Step 7 of determining an orchestration session comprises the controller system determining an orchestration session associated with one or more further client devices participating in the same media orchestration. Which client devices participate in the same media orchestration may be determined with the help of identifiers transmitted by the client devices. If a client device does not transmit an identifier, the controller system may be able to determine an identifier in a different manner, e.g. from a location of the client device obtained from a mobile communication network or from information associated with the client device or its user in a memory. For example, the controller system may receive a list of client identifiers identifying client devices participating in a media orchestration, e.g. IP addresses or other client-specific identifiers.

Media Orchestration is often about multi-device capture and multi-device playout of media. Multi-device capture can be thought of as capturing one scene or event, e.g. a concert, with multiple cameras and microphones, e.g. using various smartphones and other e.g. professional cameras. Multi-device playout is about using multiple screens and/or multiple loudspeakers to facilitate a single media experience. Media orchestration is about the coordination of various aspects of this, such as spatial orchestration for capture: aligning the various sensors spatially for video stitching or for creating a single spatial audio recording, spatial orchestration for playback: aligning the various screens and loudspeakers to create a single spatially correct experience, temporal orchestration for capture: aligning the various sensors temporally to ensure a temporally correct capture, and temporal orchestration for playback: aligning the various playback devices temporally to ensure properly aligned playback (also called inter-device media sync (IDMS)). Media orchestration may also be used to ensure proper lighting, colors, audio volumes, spatial sound, similar quality levels for stitching, for example, both for capture and for playback. Usually media orchestration processes also deal with multiple streams, i.e. at least one from or to each device participating in the orchestration. But, it may also be based on a single stream, e.g. a multi-cast or broadcast stream to multiple playout devices, the single stream possibly containing multiple elementary streams, where each receiver plays out some part of that stream in the manner orchestrated.

Another form of media orchestration may be media transformation or media editing. Suppose various media parts have already been captured. Instead of orchestrated playout, various clients can work together to edit the media or parts of it, with the purpose of creating a new (or altered) piece of content, available for other clients to consume. This may be e.g. shared annotations, i.e. adding comments to the content that may be both time-synchronized and spatially synchronized. Other examples may be the adding of a video to a collection of videos, linking it to the other videos spatially (e.g. adding a camera angle to a collection of concert recordings), or applying some content transformation process to the content, e.g. applying a video filter or audio transformation.

Orchestration data may be sent to a client device before it starts capturing or playing back media data and/or while it is capturing or playing back media data:
Initial configuration: When starting a multi-device capture or playback, information on the available devices (sensors, actuators) and their capabilities needs to be provided to the controller system. Based on this information, the controller system provides orchestration data to the client devices, e.g. what are the settings to use during capture (resolution, frame rate, zoom level, microphone gain, cropping, which device captures what, filters to be applied, etc.) or playback (what to play on which device, when to start playback, playback settings).
Stream time-aligned metadata, or (timed) metadata streams. Each media stream (video, audio, other) may be accompanied by metadata streams linked to it. These metadata streams can carry spatial (e.g. location and orientation of sensors or actuators) and/or temporal (e.g. capture time or presentation times, based on or combined with synchronized wall clocks) and/or quality information. By linking this metadata directly to the media streams, changes in the information are continually provided. This is the real-time aspect of media orchestration, continually adjusting to changing conditions and continually aligning capture or playback amongst multiple devices.

There are a number of situations, typically in an ongoing orchestration session, in which a controller system needs to cause immediate changes to one or more devices, e.g.:
If new capture sources become available, starting and stopping capture or updating capture masks (i.e. instructions on what to capture) may need to be performed directly.
If multiple participants in a VR conference no longer fit the current VR environment (e.g. having a 5^{th} participant join a 4-participant VR meeting room), all client devices may need to switch VR environment immediately.
The timing correlation between 2 media streams changes, e.g. because one media timestamp is doing a wrap-around or because a media source performs a clock reset. If the correlation is not immediately passed on, media playback will become unsynchronised.
In a multi-display playback, more displays are added and thus the content to be played is divided differently across displays. New displays will retrieve their initial configuration, but existing displays need to receive an update of the configuration.
Control over a PTZ (pan tilt zoom) camera becomes available, and a media player can thus take control of it to control the media streams created.
Circumstances change for various client devices, e.g. due to network congestion or network re-attachment on a different network, and thus the streams to be used or to be supplied should be changed.
If playback is done within a certain environment (e.g. the living room) but it moves (i.e. the user moves) outside of it to another environment (e.g. to the kitchen), the playback should immediately adjust to this.

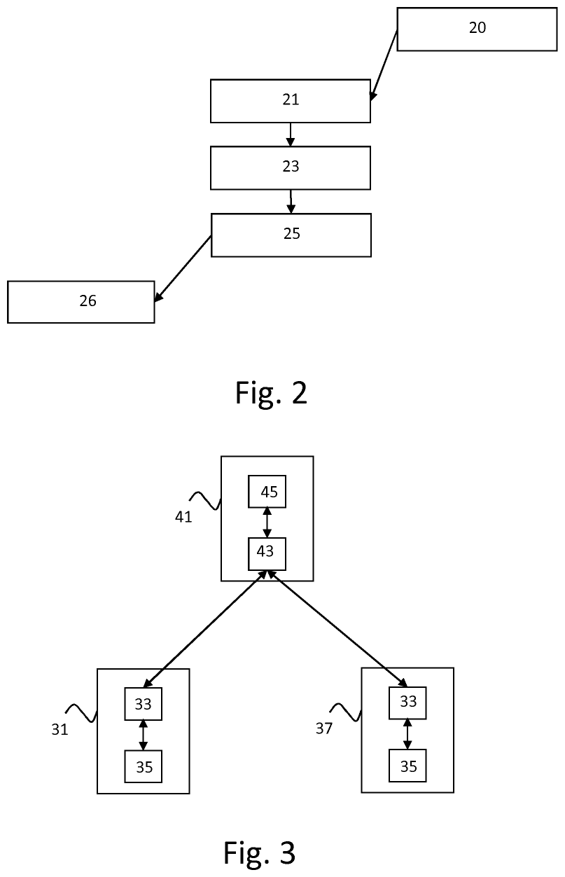

In FIG. 2, additional steps of a second embodiment of the methods of the invention are shown in a flow diagram. A step 20 comprises a further client device informing the controller system that it is stopping its participation in the certain media orchestration, for example in a scenario where multiple client devices record an event wherein each device records a spatial or temporary segment based on orchestration information. A step 21 comprises the controller system determining that at least one of the one or more further client devices has stopped participating in the media orchestration. A step 23 comprises determining new control information in response to determining that the at least one of the one or more further client devices has stopped participating in the same media orchestration. A step 25 comprises transmitting the new control information over the communication channel to the client device. A step 26 comprises the client device receiving the new control information over the communication channel from the controller system. If the media orchestration comprises more than one further client device, new control information may also be transmitted to these other client devices. This is not shown in FIG. 2.

When control information needs to be transmitted over the communication channel to the client, the controller system may send a control message over the communication channel indicating that a new version of the initial configuration is available, may push a modified version of the initial configuration over the communication channel instead of only signaling the availability of a new version, or may push partial elements of the initial configuration over the channel (specific parts which have been changed/need updating), for example.

The invention may be implemented in the MPEG-MORE standard, thereby creating an MPEG-MORE communication channel. In order to signal the MPEG-MORE communication channel to sources and sinks, the presence of a MPEG-MORE communication channel (samo, server-assisted media orchestration) may be signaled via the orchestration data using a newly defined samo:Channel element defined in the “urn:mpeg:more:schema:samo:2016” namespace and listed in Table 1. A proposed namespace prefix is “samo:”.

TABLE 1

| Element or | | |
|---|---|---|
| Attribute Name | Use | Description |
| Channel | | provides information about a MORE channel |
| @id | O | specifies an identifier for this MORE channel. |
| | (string) | |
| @schemeIdUri | M | identifies the channel scheme. The channel |
| | | scheme defines the protocol the recipient of |
| | | the MORE channel shall support. |
| @endpoint | O | provides the endpoint to the MORE channel. |
| | (string) | The endpoint conforms to the URI |
| | | specification, IETF RFC3986 [RFC3986]. |

The samo:Channel@schemeldUri specifies which protocol a MPEG-MORE source or sink may use with this MPEG-MORE channel. Table 2 below lists the protocols proposed as protocols.

TABLE 2

| @schemeIdURI | Description |
|---|---|
| urn:mpeg:more:samo:channel:websocket:2016 | The identifier indicates that the source or |
| | sink shall use the WebSocket Protocol as |
| | specified in the Clause on WebSocket |
| | Protocol. |
| | In this case, the @endpoint of the |
| | samo:Channel shall be a valid WebSocket |
| | URI as specified in 3 WebSocket URIs of |
| | IETF RFC 6455 [RFC6455]. |

MPEG-MORE control data messages may be exchanged over the WebSocket Protocol as specified in IETF RFC 6455 [RFC6455]. Data frame messages of the WebSocket Protocol mayl be set to the text type and the content may be UTF-8 encoded as specified by the WebSocket Protocol. Each WebSocket message may contain a valid MORE message compliant with the MORE message XML schema. Alternative protocols that may be used instead of WebSocket are, for example, SIP, SIMPLE, XMPP, BOSH and other protocols with similar properties.

FIG. 3 shows a client device 31, a client device 37 and a controller system 41 for enabling a media orchestration. The client device 31 comprises a communication interface 33 and a processor 35. The processor 35 is configured to use the communication interface 33 to receive communication channel setup information relating to a certain media orchestration and to use the communication interface 33 to transmit a request to the controller system 41 based on the communication channel setup information. The request represents a first step to establish a communication channel between the client device 31 and the controller system 41 in relation to the certain media orchestration, as described in relation to FIG. 1.

Establishing a communication channel preferably involves establishing a (e.g. WebSocket) connection. Establishing a connection may be performed, for example, by a 2-way or 3-way handshake. In a 2-way handshake, one entity (i.e. the client device) sends a request to a second entity (i.e. the controller system), and the other entity replies with its agreement, thereby establishing the connection. Sometimes a 3-way handshake is used, where as a third step the client device acknowledges the setup of the connection back to the controller system. Therefore, it is said here that the request sent by the client device, which may could also be called an invitation, is a first step to establish the communication channel: more steps are usually carried out, e.g. when using a 2-way or 3-way handshake in setting up a connection.

The processor 35 is further configured to use the communication interface 33 to receive control information over the communication channel from the controller system 41 after the communication channel has been established. Client device 37 may include the same components as and may be configured in the same way as described above in relation to client device 31.

The controller system 41 comprises a communication interface 43 and a processor 45. The processor 45 is configured to use the communication interface 43 to receive the request from the client device 31, to determine an orchestration session based on the request, and to use the communication interface 43 to transmit control information relating to the orchestration session over the communication channel to the client device 31 after the communication channel has been established. The controller system 41 preferably comprises a single device.

The client device 31 may be a playback device and/or a capturing device, for example. The client device 31 may be a PC, a tablet, a mobile phone, a standalone microphone or a standalone camera with a network connection (e.g. a video camera, a still camera, a webcam or an action camera), for example. The controller system 41 may comprise one or more servers, for example.

In the embodiment shown in FIG. 3, the client device 31 comprises one processor 35. In an alternative embodiment, the client device 31 comprises multiple processors. In the embodiment shown in FIG. 3, a receiver and a transmitter are combined in the communication interface 33 of the client device 31. In an alternative embodiment, the client device 31 comprises a receiver and a transmitter that are separate. The communication interfaces 35 and 45 may each comprise multiple receivers and/or multiple transmitters and may each support multiple communication technologies, e.g. connecting the client device 31 to different networks, wherein one communication technology (e.g. IP over WiFi or Ethernet) is used for the communication channel and another technology (e.g. LTE broadcast) is used for the actual media delivery. In the embodiment shown in FIG. 3, the controller system 41 comprises one processor 45. In an alternative embodiment, the controller system 41 comprises multiple processors. In the embodiment shown in FIG. 3, a receiver and a transmitter are combined in the communication interface 43 of the controller system 41. In an alternative embodiment, the controller system 41 comprises a receiver and a transmitter that are separate. The communication interface, the transmitter and/or the receiver may support multiple communication technologies and/or may comprise multiple hardware components.

The communication interfaces 35 and 45 may comprise one or more optical ports, one or more wireless transceivers and/or one or more Ethernet ports, for example. The communication interfaces 35 and 45 may comprise one or more internal interfaces. The processor 35 may be a general-purpose processor, e.g. an ARM or a Qualcomm processor, or an application-specific processor. The client device 31 may comprise other components typical for a client device, e.g. a random access memory, a solid state non-volatile memory and a battery. The processor 45 may be a general-purpose processor, e.g. an Intel or an AMD processor. The processor 45 may comprise multiple cores, for example. The processor 45 may run a Unix-based or Windows operating system, for example. The controller system 41 may comprise other components typical for a server, e.g. a power supply, a random access memory, and a solid state non-volatile or hard disk memory.

When a client device wants to participate in/contribute to a media orchestration, the client device may perform a first step of finding a certain media orchestration. This may be done with help of the user, e.g. a user may select an application with which to provide a capture, and then be given a list of orchestrations from which he can select one to contribute to. Or, something similar may be available on a website, a QR code at an event such as a concert or sports event may give this information, etc. For a media playout, a user may select content to be played back on a device, e.g. by selecting content from a content guide, on a website or by receiving a recommendation from a friend, e.g. via a social network, e.g. a link. Also, devices and their capture or presentation capabilities may be discovered via the network. This is usually a local process, using multicast on a local network to perform device and service discovery, e.g. using UpnP or DLNA or modified versions or equivalent protocols. The device may then be instructed by some other device to start e.g. playback, as in Chromecast or Airplay. Alternatively, this pairing may need some sort of confirmation on the device, e.g. similar to a first-time pairing in Bluetooth, to prevent malicious use.

Common scenarios for orchestration are:
Users actively selecting orchestration on multiple devices. An example of this is that users scan the QR code at an event which leads them to a dedicated application for providing user generated content for that specific event. Another example is a user at home switching on all his equipment, and then using his tablet to select a piece of content and selecting the television, the stereo and his tablet together for combined playback.
One device starting a capture or playout, and other devices discovering this and joining the orchestration. Discovery can be active (searching for it on the local network), or passive (being invited).

The result of this first step is that a client receives an initial configuration for his capture or playout, as part of the media orchestration. Such configuration will typically contain:
For capture: the destination network address to provide the content to, the codecs and containers to be used for the media and specific settings (such as frame rate, bitrate, video filters, camera settings) to use, the start and end time for capture, instructions to synchronize the wall clock with a certain clock server, instructions to provide timestamps in a certain format, to provide location and orientation metadata, etc.
For playback (often also called playout or presentation): content location, instructions on when to start playout and which parts of the content to play out.

Such an initial configuration can be created dynamically. Once a client requests the initial configuration for a specific capture or playout, the available information about the client (e.g. network address, location, capabilities) can be used to already determine the suitable controller system and perhaps certain other settings such as those mentioned above. Configuration is thus not a static setting for a session for all client devices involved, but can be device-specific and created on-the-fly once client devices join the session.

Part of this initial configuration may be the instruction to set up a communication channel to a controller system. This instruction may for example include a URI of the controller system, the protocol to use for the control channel and a media orchestration session ID. Once such a channel is setup, it may be used by the controller system to actively sent additional instructions to the client device. The initial configuration may be part of an MPEG-DASH Manifest, or may be part of some other content announcement, e.g. part of EPG information or part of a SAP announcement or be supplied as a parameter in an SDP description supplied in a media session setup, etc.

Normally, users control their devices and thus it is a user's intention to start contributing to a certain media orchestration. But, many devices are also enabled to be remote controlled, e.g. security cameras and digital signs in shop windows or on the airport. Such devices may be used as part of an orchestration in which they normally will be told remotely to participate in such an orchestration. This may be instigated locally, e.g. a user scanning a QR code of a screen that may be used for an orchestration.

To enable media orchestration, client devices need to be controlled by the same functional entity, i.e. the same controller system, and preferably by the same device. To ensure that client devices 31 and 37 participate in the same media orchestration at controller system 41, two things need to be arranged for. First, both client devices 31 and 37 need to be connected to the same controller system 41. This is a dynamic process, because different client devices may be used together at different times.

Second, the controller system 41 needs to be aware that both client devices 31 and 37 are part of the same orchestration (as a single controller system may be in control of a multitude of orchestrations involving many different client devices). The controller system 41 therefore determines whether client devices 31 and 37 are part of the same orchestration session. This may require the same orchestration session identifiers to be shared between all client devices involved in the session and the controller system linking the various client devices together in the same sessions in order to orchestrate them together. However, client devices may not be aware of which other client devices are involved in the session or even that other client devices are part of an orchestration session.

If a client device does not know the controller system and/or does not know the session ID, a solution needs to be found to ensure that client devices can participate in the same media orchestration controlled by the same controller system. Table 3 shows the two problem dimensions and thus the four solution areas:

TABLE 3

| | | | Client does not know the |
|---|---|---|---|
| | Client knows the session ID | | session ID |
| Client knows | (A) | Basic scenario | (B) Server-based session |
| the controller | | | discovery |
| Client does | (C) | Server discovery | (D) Combination of |
| not know the | | process, e.g. using | scenarios (B) and (C) |
| controller | | 1. Lookup | |
| | | 2. Re-directs | |
| | | 3. Proxy | |

Scenario (A) is the simplest scenario. Client devices 31 and 37 know the session ID and know the URI of the controller system 41. Here the session ID and the URI of the controller system 41 are somehow shared between the client devices 31 and 37 beforehand. This can be arranged for in typical usage scenarios.

In a first usage scenario, client devices 31 and 37 are paired by the user beforehand. Nowadays, when users use a casting mechanism (e.g. Chromecast, Airplay) their devices discover other devices and the services available first, usually using some broadcast or multicast mechanism, as known also from DLNA or UPnP, often called device discovery and service discovery. Then, a list of available devices and/or services is shown to the user, who may select the proper device(s) and service(s) from the list. For example, a user may start a media playout session on client device 31. Another client device 37 may then use device and service discovery to detect the client device 31 and this specific media playout session (i.e. as a service), and select it to join the session. The session ID may be indicated during the discovery process or may be made available after joining the session, e.g. only after an authorization process. The same may be accomplished using other pairing technologies, such as Bluetooth pairing or using near field communication.

In a second usage scenario, client devices 31 and 37 may use other (messaging) infrastructures to share a session ID with each other. Typical scenarios are that a user sends an invite to other users using some messaging platform (e.g. WhatsApp, SMS, Twitter, Facebook messaging), or sharing a link on a site (e.g. their Facebook page, or on a live blog), thereby sharing the session ID with others. Other users may then ‘instruct’ their device to join the session by clicking a link. Such a mechanism may of course also be included in a new piece of software, e.g. a content playback application including such social network features.

In a third usage scenario, client devices 31 and 37 may be offered a list of active sessions to join through using a certain application. E.g. when a user is in a stadium, the home team may have an app that allows for live user generated content. When users have this app installed and they open it, the app may show a live event currently in progress, which users can select to join this particular capture orchestration session. Alternatively, the users may have an app installed that shows nearby media orchestrations, e.g. shown on a map, and select one to join there.

In a fourth usage scenario, users may share a session ID through other means, e.g. share it offline and input this into their application manually. This is quite similar to current-day conference calls, where a conference ID is shared beforehand and manually entered by the users joining the conference. Or, an event may offer a QR code that contains the information, for example. When sharing the session ID, the URI of the controller system may also be included, and possibly the protocol or protocols to be used as well. The URI of the controller system and the protocol(s) may comprise a default URI and default protocol(s) configured in the application that is used.

In scenario B, the client devices 31 and 37 both set up a communication channel to the same server, but the client devices (or at least one of the client devices) are not able to indicate the orchestration session, e.g. by supplying an orchestration session ID. A typical example of this is a generic user generated content application offered by a news provider. Many users may provide (live) streams of content they deem newsworthy, and the news provider may combine (i.e. orchestrate) various streams together to create a news item. Instead of using session IDs, the controller system 41 of the news provider may be configured to cluster client devices, including client devices 31 and 37, together based on proximity. For example, when the news provider defines a certain point of interest, all client devices within 500 meter of this point are all grouped together in the same orchestration. In this case, when the client devices transmit their request in order to establish a communication channel, they can indicate their location, or this location may be detected and indicated by the network. Examples of location information may be GPS coordinates, cell ID, address information.

Other types of information may also be usable to determine the orchestration (session) that the client devices 31 and 37 may belong to. Network address, e.g. IP address, may be used for this, as multiple devices behind a NAT share the same IP address. In such a setting, e.g. multiple clients in the same local network in a home, multiple client devices having the same IP address are likely to be in physical proximity, and may thus be used in a shared session. Nearby SSIDs may also provide location information, similar to what is used in Google Location Services.

If the controller system 41 determines the orchestration session ID itself instead of receiving it from the client devices 31 and 37, as described in relation to scenario B, the controller system 41 may or may not provide the determined orchestration session ID to the client devices 31 and 37. The goal of the session ID is for the controller system to be able to identify which client devices belong to which orchestration session. If the controller system determines the session ID itself and is the correct controller system, the client device may not need to receive the session ID. On the other hand, it the controller system determines the session ID itself, but is not the correct controller system, i.e. the client device needs to use a different controller system (see also scenario C), it may be advantageous to have the controller system provide the session ID to the client device.

In scenario C, the client devices 31 and 37 do have/know a shared session ID, but they do not know which controller system to contact. This may be the case if there are multiple controller systems for the purposes of scalability, or e.g. if different controller systems are offered by different companies.

In this scenario, the client devices may first contact an initial controller system, e.g. a pre-configured controller system, or a default controller system as provided in the channel setup information. Two client devices in a single session may connect to the same controller system by chance, but may also end up connecting to different controller systems. Therefore, mechanisms are needed to ensure that client devices in the same orchestration session establish a communication channel with the same controller system. This may be done using the following mechanisms, for example.

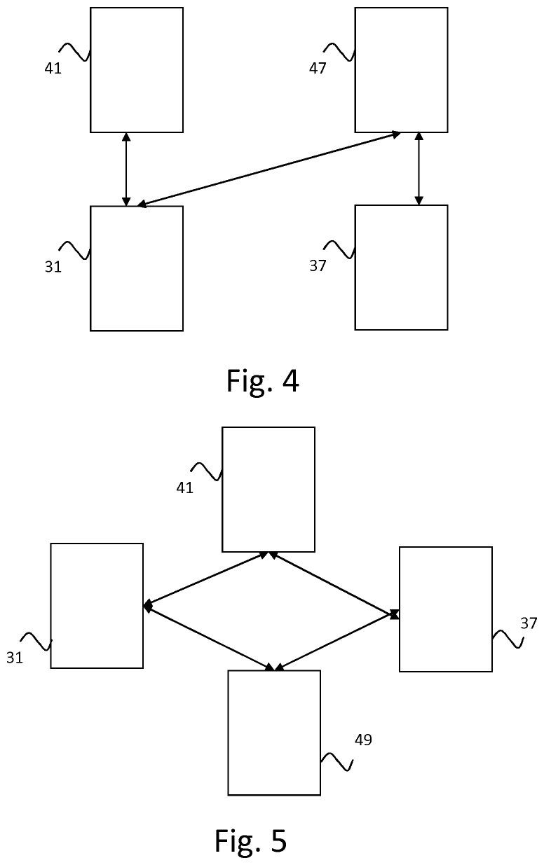

A first mechanism involves the client device 31 contacting a controller system 41, but being re-directed to a different controller system 47. This is shown in FIG. 4. Client device 31 first contacts controller system 41, but controller system 41 is not the controller system responsible for this orchestration session. Controller system 41 may use a lookup as described below, in this case to determine that controller system 47 is the controller system responsible for this session, and send a redirect message to client device 31 to redirect client device 31 to controller system 47. Client device 31 may then set up a communication channel to controller system 47. Alternatively, the re-direct process may be performed a number of times, instead of just one time, before arriving at the right controller system.

A second mechanism involves client devices 31 and 37 first performing a lookup of the controller system address using the orchestration session ID. This is shown in FIG. 5. First, both client devices 31 and 37 perform a lookup at a lookup server 49 using the session ID. To perform a lookup, various mechanisms could be used. Known mechanisms include hierarchical schemes (such as or similar to DNS lookups), flooding methods (e.g. sending a multicast or broadcast message to various / all servers involved), using gossiping protocols such as known from peer-to-peer networking, using distributed hash tables. Either client device 31 and/or client device 37 use such a mechanism, or client device 31 and/or client device 37 contact lookup server 49 and lookup server 49 uses such a mechanism to find the URI of the right controller system 41, e.g. at some other lookup server. Once client devices 31 and 37 have discovered the URI of the controller system 41, they can setup a communication channel to the controller system 41. After the lookup, this part of the scenario is similar to scenario A.

The lookup server 49 may comprise solid state memory, e.g. one or more Solid State Disks (SSDs) made out of Flash memory, or one or more hard disks, for example.

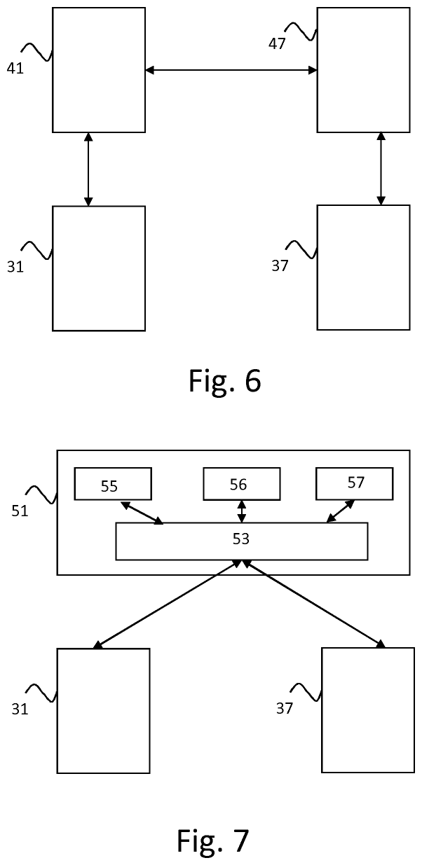

A third mechanism involves controller 41 and controller 47 cooperating. This is shown in FIG. 6. Having a single server controlling the various client devices as part of a single media orchestration is an easy way to make sure that a single entity is in control of the entire orchestration. But, it is not the only way: a single functional controller may be distributed over various physical servers.

As a first example, controller 41 may act as a proxy for controller 47. Client device 31 contacts controller system 41, but controller system 41 somehow determines (e.g. using a lookup or from locally available information) that controller system 47 is the controller system responsible for this session, as indicated by the session ID provided by the client device 31. In this case, the controller system 41 forwards the request for a communication channel to controller system 47. Some transformation, e.g. protocol conversion, may be performed before forwarding the request or messages. All messages between client device 31 and controller system 47 will go via controller system 41. This may be considered to create a first communication channel between client device 31 and controller system 41 and a second communication channel between controller system 41 and controller system 47. More than one controller system may be a proxy in between the client device and the ultimately final controller system, i.e. there may be a cascade of proxies.

As a second example, federation between different controller systems may be implemented. For example, controller system 41 may be controlling client device 31, controller system 47 may be controlling client device 37, and controller systems 41 and 47 may be exchanging information to determine how to control their respective client devices. This federation may also involve the use of a master controller system and client controller systems. For example, a master controller system may orchestrate one part of the orchestration (e.g. what client device plays what part of the content) and client controller systems may orchestrate a different part of the orchestration (e.g. the time synchronization between client devices, or the spatial alignment of the client devices).

Multiple controller systems may be used for reasons of scalability, but different controller systems may also differ in the functionality they offer. For example, a certain controller system may be either a temporal orchestration server (i.e. an MSAS or Media Synchronization Application Server) or a spatial orchestration server. In this case, multiple controller systems may be needed for a single orchestration session. A lookup of a controller system may thus also be based on the functionality required and/or the results of a lookup may include multiple results, with the functionality offered by the controller systems included in the results.

Combinations of these types of federation are of course also possible. In all these cases, each client device has a communication channel to its own controller system, or possibly to more than one controller system in case the functionality is distributed amongst various controller systems, e.g. when different controller systems control different aspects of the media orchestration.

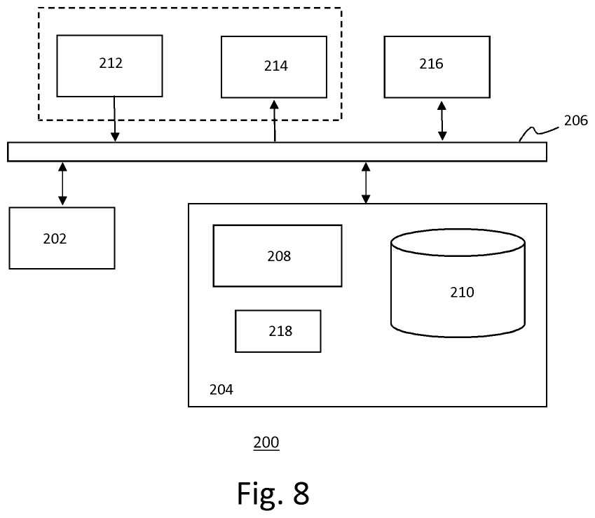

Instead of or in addition to increasing scalability by using multiple controller system, scalability may also be enhanced by using a cloud-based controller system 51, see FIG. 7. The cloud-based controller system 51 comprises a cloud layer 53 and three hardware components 55, 56 and 57. The cloud layer 53 is associated with a certain URI and forms the communication interface towards the client devices 31 and 37. A certain hardware component may be used for a certain media orchestration session depending on certain aspects of the media orchestration, e.g. the locations of participating client devices and/or the type of the media orchestration, and/or depending on the load of the three hardware components 55, 56 and 57, for example.

Another orchestration model is a peer-to-peer model. Also in such a model, it makes sense to set up communication channels. These communication channels may be setup between all peers, only between some peers, and may have various layouts: full mesh, ring topology, master-slaves. For example, if one client device runs out of battery and needs to inform the other client devices it is leaving the orchestration, it may inform the others about this, which may then decide upon a proper action to accommodate the departure.

It may happen that no controller system is in charge of a media orchestration yet, e.g. in case a new session is added. A controller system 41 may perform a lookup to determine which controller system is the controller system responsible for a particular orchestration. If no session is found, the controller system 41 may then become the controller system responsible for this session, possibly also (depending on the lookup mechanism used) informing other controller systems of this. From then on, other controller systems may be able to perform a lookup to determine that controller system 41 is the controller system responsible for this session.

Scenario D is a combination of scenario B and scenario C. In general, first the session ID for client devices 31 and 37 will be determined (see scenario B), e.g. by an initial controller system, and then the appropriate controller system can be found (scenario C). Sometimes this will only take a single step, e.g. in a local area network there may be a single controller system which orchestrates all sessions for local devices and the initial controller system may often or always be the appropriate controller system. This scenario may place a larger burden on controller systems, as controller systems may need to be able to both determine session IDs and find appropriate controller systems. Since this scenario will likely mostly be used in local media orchestrations, i.e. friends turning on their device and starting their application and searching for locally available sessions to join, this scenario is still a viable scenario.

FIG. 8 depicts a block diagram illustrating an exemplary data processing system that may perform the methods as described with reference to FIGS. 1 and 2.

As shown in FIG. 8, the data processing system 200 may include at least one processor 202 coupled to memory elements 204 through a system bus 206. As such, the data processing system may store program code within memory elements 204. Further, the processor 202 may execute the program code accessed from the memory elements 204 via a system bus 206. In one aspect, the data processing system may be implemented as a computer that is suitable for storing and/or executing program code. It should be appreciated, however, that the data processing system 200 may be implemented in the form of any system including a processor and a memory that is capable of performing the functions described within this specification.

The memory elements 204 may include one or more physical memory devices such as, for example, local memory 208 and one or more bulk storage devices 210. The local memory may refer to random access memory or other non-persistent memory device(s) generally used during actual execution of the program code. A bulk storage device may be implemented as a hard drive or other persistent data storage device. The processing system 200 may also include one or more cache memories (not shown) that provide temporary storage of at least some program code in order to reduce the number of times program code must be retrieved from the bulk storage device 210 during execution.

Input/output (I/O) devices depicted as an input device 212 and an output device 214 optionally can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 8 with a dashed line surrounding the input device 212 and the output device 214). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 216 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 200, and a data transmitter for transmitting data from the data processing system 200 to said systems, devices and/or networks. Modems, cable modems, and Ethernet cards are examples of different types of network adapter that may be used with the data processing system 200.

As pictured in FIG. 8, the memory elements 204 may store an application 218. In various embodiments, the application 218 may be stored in the local memory 208, he one or more bulk storage devices 310, or separate from the local memory and the bulk storage devices. It should be appreciated that the data processing system 200 may further execute an operating system (not shown in FIG. 8) that can facilitate execution of the application 218. The application 218, being implemented in the form of executable program code, can be executed by the data processing system 200, e.g., by the processor 202. Responsive to executing the application, the data processing system 200 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 202 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A method of enabling a media orchestration, said media orchestration orchestrating multiple devices to process at least one media stream, said method comprising:
receiving communication channel setup information relating to a certain media orchestration at a client device;
transmitting from the client device a request to a controller system based on said communication channel setup information, said request representing a first step to establish a communication channel between said client device and said controller system in relation to said certain media orchestration; and
receiving control information over said communication channel at said client device from said controller system after said communication channel has been established.

2. A method as claimed in claim 1, wherein said communication channel setup information comprises an address of said controller system, one or more protocol identifiers identifying one or more protocols that may be used to access said controller system and/or an orchestration session identifier.

3. A method as claimed in claim 1, further comprising the step of including an identifier in said request before transmitting said request, said identifier enabling said controller system to determine an orchestration session.

4. A method as claimed in claim 3, wherein said identifier comprises an orchestration session identifier and/or a location identifier.

5. A method of enabling a media orchestration, said media orchestration orchestrating multiple devices to process at least one media stream, said method comprising:
receiving a request from a client device at a controller system, said request representing a first step to establish a communication channel between said client device and said controller system in relation to a certain media orchestration;
determining an orchestration session based on said request; and
transmitting control information relating to said orchestration session over said communication channel to said client device after said communication channel has been established.

6. A method as claimed in claim 5, wherein determining an orchestration session comprises determining an orchestration session associated with one or more further client devices participating in the same media orchestration.

7. A method as claimed in claim 6, further comprising determining that at least one of said one or more further client devices has stopped participating in the same media orchestration, determining new control information in response to determining that said at least one of said one or more further client devices has stopped participating in the same media orchestration, and transmitting said new control information over said communication channel to said client device.

8. A method as claimed in claim 5 further comprising determining an identifier in relation to said request and wherein determining an orchestration session comprises determining said orchestration session based on said identifier.

9. A method as claimed in claim 8, wherein said identifier comprises an orchestration session identifier and/or a location identifier.

10. A computer program or suite of computer programs comprising at least one software code portion or a computer program product storing at least one software code portion, the software code portion, when run on a computer system, being configured for performing the method of claim 1.

11. A client device for enabling a media orchestration, said media orchestration orchestrating multiple devices to process at least one media stream, said client device comprising:
a communication interface; and
at least one processor configured to use said communication interface to receive communication channel setup information relating to a certain media orchestration, to use said communication interface to transmit a request to a controller system based on said communication channel setup information, said request representing a first step to establish a communication channel between said client device and said controller system in relation to said certain media orchestration, and to use said communication interface to receive control information over said communication channel from said controller system after said communication channel has been established.

12. A controller system for enabling a media orchestration, said media orchestration orchestrating multiple devices to process at least one media stream, said controller system comprising:
a communication interface; and
at least one processor configured to use said communication interface to receive a request from a client device, said request representing a first step to establish a communication channel between said client device and said controller system in relation to a certain media orchestration, to determine an orchestration session based on said request, and to use said communication interface to transmit control information relating to said orchestration session over said communication channel to said client device after said communication channel has been established.

13. A controller system as claimed in claim 12, wherein said controller system comprises a single device.

14. A data format for communication channel setup information enabling a media orchestration, said media orchestration orchestrating multiple devices to process at least one media stream, said data format comprising an address of a controller system for enabling a media orchestration.

15. A data format as claimed in claim 14, further comprising one or more protocol identifiers identifying one or more protocols that may be used to access the controller system and/or an orchestration session identifier.
